(19) United States
(12) Patent Application Publication
(10) Pub. No.: US 2019/0170277 A1
(43) Pub. Date: Jun. 6, 2019

(54) Fitting for Producing a Leaktight Connection Comprising a Retaining Element with Contact Surfaces

(71) Applicant: Viega Technology GmbH & Co. KG, Attendorn (DE)

(72) Inventors: Alexander Kost, Attendorn (DE); Andreas Müller, Freudenberg (DE); Anton Hartmann, Attendorn (DE); Benedikt Wiethoff, Niedersalwey (DE); Ulrich Arning, Attendorn (DE); Christian Rischen, Eslohe (DE)

(21) Appl. No.: 16/302,240

(22) PCT Filed: May 15, 2017
(86) PCT No.: PCT/EP2017/061594

§ 371 Date: Nov. 16, 2018

(30) Foreign Application Priority Data
May 17, 2016 (DE) 10 2016 109 034.4

(51) Int. Cl. F16L 13/14

(52) U.S. Cl. CPC F16L 13/142

(57) ABSTRACT

The invention relates to a fitting for producing a leaktight connection with a pipe end, having at least one pressing portion designed for pressing and the insertion of a pipe end, having at least one sealing and at least one retaining element. The sealing and retaining elements are arranged in the pressing portion. The retaining element is substantially annular. The annular shape defines axial and circumferential directions. The retaining element has two ends with respect to the circumferential direction. Specifying a fitting with a retaining element is achieved when the retaining element has, at each of the two ends, at least one contact surface extending at least partially in the circumferential direction. The contact surfaces are designed to be brought into contact with one another upon pressing the pressing portion. The invention relates to a system and method for producing a leaktight connection between a pipe end and fitting.

The invention relates to a fitting for producing a leak-tight connection with a pipe end, with at least one pressing portion which is configured for the insertion of a pipe end and for compression, with at least one sealing element and with at least one retaining element, wherein the sealing element and the retaining element are arranged in the pressing portion, wherein the retaining element is substantially annular, wherein the annular form defines a circumferential direction and an axial direction, and wherein the retaining element has two ends in relation to the circumferential direction. The invention furthermore relates to a system and a method for producing a leak-tight connection between a fitting according to the invention and a pipe end.

Fittings of the type cited initially are used in the prior art, inter alia to produce a leak-tight connection in pipeline systems and in steel constructions, in particular for conveying fluids or gases in pipes and their connections. A pipe end is thereby inserted in a pressing portion of the fitting and at least the pressing portion of the fitting is compressed radially inwardly with the pipe end, in particular via a pressing machine, and in this way a leak-tight permanent connection is created. The connection may also be inseparable, i.e. it cannot be separated again without destruction of the pipe end or fitting.

A generic fitting has at least one sealing element and a retaining element. Usually, the connection to be created is sealed by the sealing element, which for example consists of an elastic material and is brought into tight contact against the fitting and the pipe end. The retaining element usually serves primarily for mechanical fixing of the connection and prevents undesirable release of the connection. The retaining element normally consists of a hard non-elastic material, and creates a force-fit or form-fit connection with the workpiece, in particular by pressing or cutting into the workpiece.

EP 0 922 896 A1 and DE 102 07 201 A1 disclose fittings which have retaining elements configured as cutting elements. The cutting element and the sealing element are in particular arranged in two different portions on an internal circumferential surface of the fitting.

Furthermore, EP 1 593 899 A1 and WO 2010/089188 A1 describe fittings in which a retaining element, configured as a cutting element, and a sealing element are jointly arranged in a pressing portion. The cutting element and sealing element are separated here by an intermediate separating ring.

EP 1 593 898 A1 furthermore discloses a sealing element for a fitting made from an elastic material, wherein cutting elements are embedded inside the sealing element.

The problem with retaining elements configured as cutting elements however is that these usually have complex forms, and cutting edges must be worked into a hard material. Cutting elements are often configured as punched and bent parts or formed parts, and are therefore relatively complex and cost-intensive to produce. Furthermore, in particular if the fitting is used in the ground, the retaining element is often exposed to corrosive conditions. When the retaining element is formed as a cutting element, the material strength in the region of the cutting edge is low for structural reasons, so that the cutting element often has poor corrosion resistance. The cutting edge also often does not offer a flat contact with the pipe end, whereby corrosive media can easily penetrate through the retaining element and hence reach the interior of the fitting.

A retaining element in a fitting with simplified production is known from WO 2008/053315 A1. The retaining element is configured as an open ring with a recess and two ends relative to the circumferential direction, so that under a compression directed radially inwardly, the retaining element can be compressed easily in the circumferential direction. The recess in WO 2008/053315 A1 is dimensioned such that after compression, a recess remains in the ring shape of the retaining element and the ends do not butt up against each other in the circumferential direction. Thus even on dimensional deviations of the elements of the fitting and pipe end, it is guaranteed that the retaining element can always easily be compressed in the circumferential direction under a compression directed radially inwardly. Because a recess remains after compression and the retaining element therefore has an open ring shape in the compressed state, the retaining element is however still permeable to corrosive media which can easily penetrate into the fitting via the recess.

The present invention is based on the object of indicating a fitting with a retaining element which has an improved corrosion protection and in particular can be produced economically. Furthermore, a system and a method are indicated for producing a leak-tight connection between a fitting according to the invention and the pipe end.

According to a first teaching, said object concerning a fitting is achieved in that the retaining element has at each of the two ends at least one contact surface which extends at least partially in the circumferential direction, and the contact surfaces are configured to be brought into contact with each other upon compression of the pressing portion.

By arranging contact surfaces at the circumferential ends of the retaining element, wherein the contact surfaces are brought into contact with each other by compression, an additional sealing effect of the retaining element can be achieved. In particular, the penetration of corrosive media or other foreign substances into the interior of the fitting is inhibited. Furthermore, an additional second seal against the conveyed medium is achieved, which is independent of temperature and media because of the metallic seal by the retaining element. This has the advantage that the fitting can be used in an emergency in the case of failure of the primary seal, if this is damaged for example in the event of fire at excessively high temperatures or by the conduction of incorrect media, since the additional seal from the retaining element prevents total failure of the connection or can at least largely avoid this.

Because the contact surfaces are configured as surfaces running at least partially in the circumferential direction of the retaining element, it is guaranteed that even on dimensional deviations or tolerances in the elements to be compressed, both the additional sealing effect and a compressibility in the circumferential direction are retained. The contact surfaces running at least partially in the circumferential direction of the retaining element are in particular configured as sliding surfaces and allow the respective contact surfaces to slide over each other, so as to achieve a sealing effect for a range of different circumferences of the retaining element to be achieved by compression. Thus, in contrast to retaining elements which have contact surfaces running perpendicularly to the circumferential direction, the retaining element can compensate for dimensional deviations of the elements to be compressed. Also, a particularly even compression of the retaining element and pipe end is achieved.

The term “substantially annular” in relation to the configuration of the retaining element means that the retaining element has at least approximately a closed form in a circumferential direction, which form is adapted in particular to the circumferential form of the pipe to be inserted. For a pipe end with circular cross-section, the retaining element may assume the form of a circular ring or a portion of a circular ring. Other embodiments are possible for further applications, for example shapes or portions thereof based on elliptical or polygonal forms.

The retaining element comprises a material which has adequate hardness and deformability for compression. In particular, the retaining element comprises or consists of metal.

The retaining element is preferably arranged at the side of the sealing element distally to a pipe end inserted in the pressing portion. Thus the retaining element may deploy the additional sealing effect against the outside of the connection of the fitting with the pipe end. This is advantageous in particular when the fitting is used underground or under other corrosive conditions. It is however also conceivable that the retaining element is arranged at the side of the sealing element proximally to a pipe end inserted in the pressing portion, and hence achieves an additional sealing effect of the fitting against a medium conducted in the fitting or pipe end.

Via the contact surfaces standing in contact with each other after compression, the fitting has a closed annular form. In one embodiment of the fitting, the retaining element is configured to be brought into a closed annular form by compression of the pressing portion, i.e. before compression the retaining element has an open annular form, and after compression a closed annular form. The open annular form before compression can easily be achieved by means of a recess in the retaining element. During compression, the contact surfaces come into contact with each other, wherein however dimensional deviations in the elements can be compensated via the contact surfaces which run at least partially in the circumferential direction of the retaining element, and in particular the contact surfaces slide over each other. After compression, the retaining element remains in a closed annular form via the contact surfaces standing in contact, and thus achieves an additional sealing effect.

In an alternative embodiment of the fitting, before compression the retaining element already has a closed annular form, i.e. in particular the ends relative to the circumferential direction are already in contact. On compression, additional contact surfaces come into contact with each other, whereby a closed annular form is retained.

In a further embodiment of the fitting, the contact surfaces are formed via at least one surface inclined relative to the circumferential direction. Via such inclined surfaces which stand at an angle to the circumferential direction, the contact surfaces can easily be produced and also have sliding properties. On compression of the fitting and an associated compression of the retaining element in the circumferential direction, the inclined surfaces then slide on each other and thus constitute contact surfaces which, in a simple fashion, allow further compression of the retaining element in the circumferential direction and create a sealing effect via the contact.

In another embodiment of the fitting, the contact surfaces are formed via rounded surfaces. For example, contact surfaces are provided in the form of ball segments or ball domes. Such embodiments also offer suitable contact surfaces.

In a further embodiment of the fitting, the contact surfaces run substantially parallel to each other. In this way, the forms of the contact surfaces at the respective ends of the retaining element are adapted to each other, in particular as positive and negative forms relative to each other, and thus create contacts of particularly large surface area after a compression. The term “substantially” here means that deviations in parallelism of form of the surfaces occur solely within the range of production tolerances of the retaining element.

In a further embodiment of the fitting, the ends of the retaining element are arranged offset to each other in the axial direction. In this way, the ends of the retaining element are pushed past each other on compression of the retaining element in the circumferential direction. The contact surfaces may here be configured to allow the axially mutually offset ends to slide past each other on compression. In particular, the ends of the retaining element are arranged axially offset to each other before compression, but lie in one plane. This achieves minimal use of material for a closed annular form in the uncompressed state.

In one embodiment of the fitting, the cross-section of the retaining element in the circumferential direction is formed so as to be substantially elliptical. In particular, the retaining element has a circular cross-section. In this way, the retaining element can be produced particularly simply and economically, in particular by forming a semifinished product such as a wire. With an elliptical cross-section, in contrast to retaining elements configured with for example sharp-edged coating elements, a particularly large contact area is provided between the retaining element and the inserted pipe end on compression. Thus in particular, the additional sealing effect of the retaining element is reinforced.

In one embodiment of the fitting, the cross-section of the retaining element in the circumferential direction is substantially rectangular. In particular, the cross-section may be substantially square. This embodiment too allows simple and economic production from a semifinished product. With a rectangular or square cross-section, a large contact area with the pipe end can be created, whereby an additional cutting effect may result from the corners or edges in the cross-section. The cross-section of the retaining element in the circumferential direction may have at least one recess, in particular also in an elliptical or rectangular cross-section as described above. The recess allows an additional structure to be inserted into the retaining element, which promotes the pressing or cutting of the retaining element into the material of the pipe end without complex production processes being required to create cutting edges. The recess is in particular rectangular, V-shaped or configured in the form of a circle portion or slot. For the V shape, the opening angle of the recess may also be varied depending on use and materials.

Similarly, several recesses may be provided in the cross-section. In particular, a recess may be arranged at each mutually opposing end of the cross-section, for example two opposing recesses or four recesses rotated by 90° to each other. In this way for example, a cutting effect of the retaining element into the material of the fitting wall may be achieved.

Also, the retaining element may comprise at least one cavity in the cross-section in the circumferential direction. This allows savings in material and weight.

The cross-sectional forms of the retaining element described above constitute an independent solution which may solve the technical problem outlined above independently, even without the contact surfaces described.

In a further embodiment of the fitting, an additional separating element is provided which is arranged between the sealing element and the retaining element. The additional separating element may in particular protect the sealing element from damage during compression and contribute further to the leak-tightness. The additional separating element in particular comprises plastic, metal, wood, minerals and/or composite materials, or consists of these materials.

According to a further teaching, the object outlined above concerning a system for producing a leak-tight connection is achieved in that the inner surface of the pressing portion and the retaining element and the sealing element are adapted to the outer surface of the pipe end. With a corresponding adaptation, both the deformation under compression and the resulting leak-tightness can be optimised. In the simple case of a circular cross-section of the pipe end, for example the inner diameter of the retaining element is adapted to the outer diameter of the pipe end.

According to a further teaching, the object outlined above concerning a method for producing a leak-tight connection is achieved in that the pipe end is inserted at least into the pressing portion of the fitting, wherein the fitting is compressed at least at the pressing portion, whereby the sealing element between the fitting and the pipe end is deformed and the at least one retaining element is pressed into the material of the pipe end, and wherein by means of the compression, the contact surfaces of the retaining element are brought into contact with each other.

As already explained above in relation to the fitting, by the configuration of the contact surfaces it can be achieved that, even on dimensional deviations or tolerances in the elements to be compressed, both an additional sealing effect from the retaining element and a compressibility in the circumferential direction of the retaining element are guaranteed. Also, a particularly even compression of the retaining element and pipe end is achieved.

The at least one retaining element may in addition be pressed into the material of the fitting wall. This achieves an additional retaining effect of the fitting and pipe end.

The compression may create a force-fit and/or a form-fit connection between the retaining element and pipe end or between the retaining element and fitting wall.

With regard to further embodiments and advantages of the system and method, reference is made to the statements above in relation to the fitting and to the following description of the drawings. The drawings show:

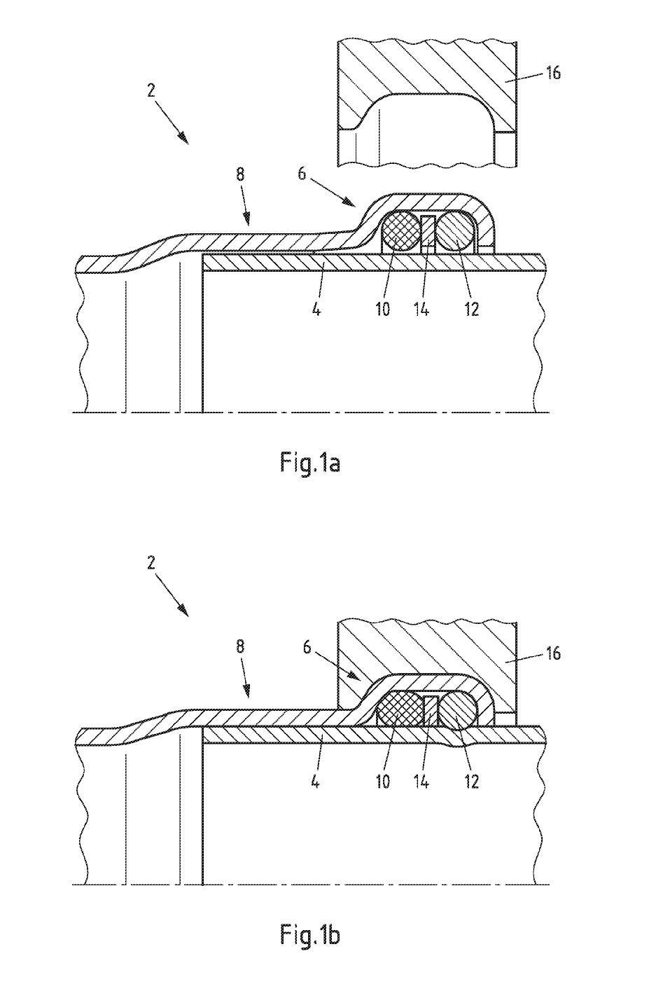

FIG. 1a, b a first exemplary embodiment of a fitting 2 for producing a leak-tight connection with the pipe end 4, in a sectional view,

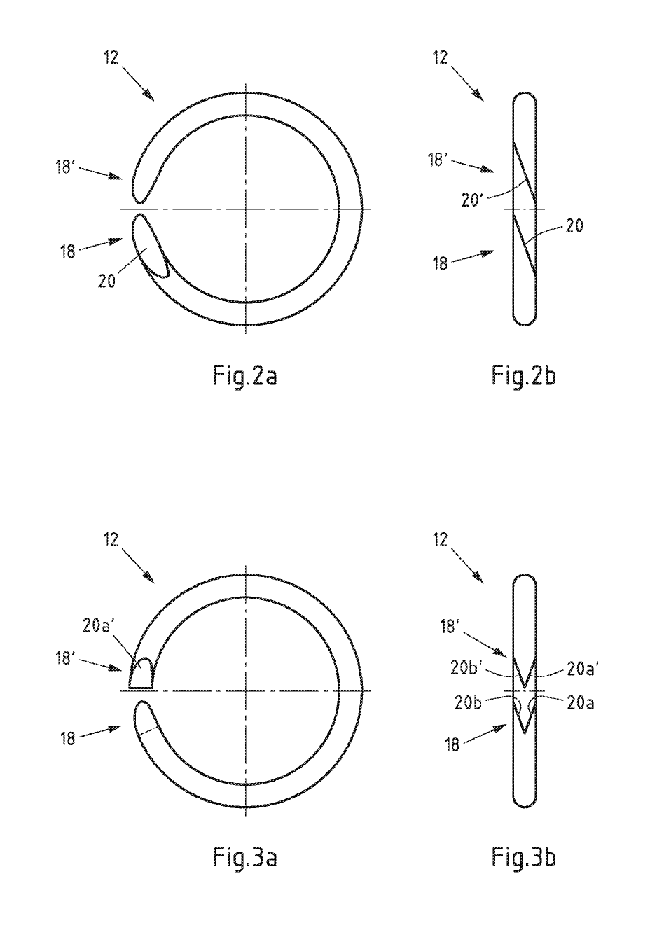

FIG. 2a, b a first exemplary embodiment of a retaining element 12, in a front view and top view respectively,

FIG. 3a, b a second exemplary embodiment of a retaining element 12, in a front view and top view respectively,

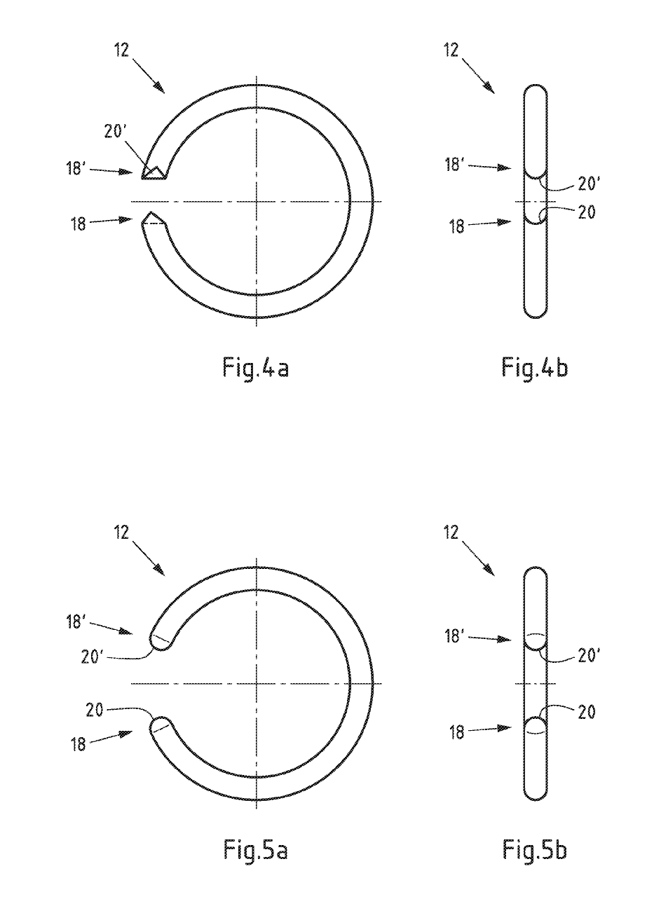

FIG. 4a, b a third exemplary embodiment of a retaining element 12, in a front view and top view respectively,

FIG. 5a, b a fourth exemplary embodiment of a retaining element 12, in a front view and top view respectively,

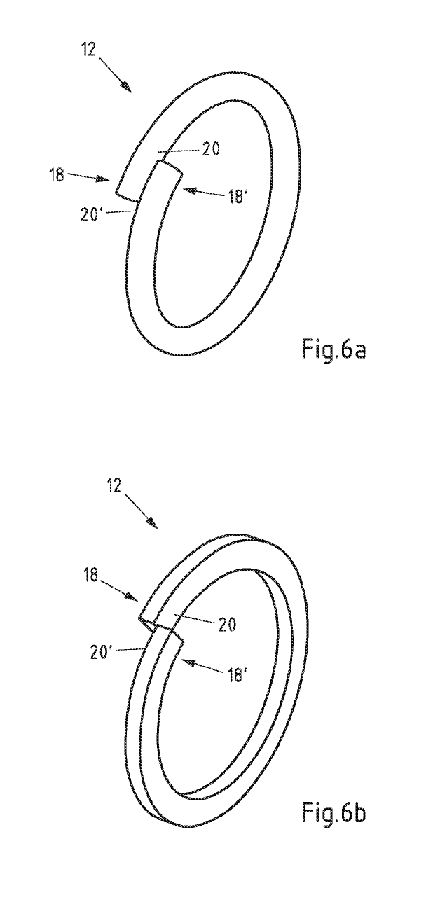

FIG. 6a, b a fifth and sixth exemplary embodiment of the retaining element 12, in perspective views, and

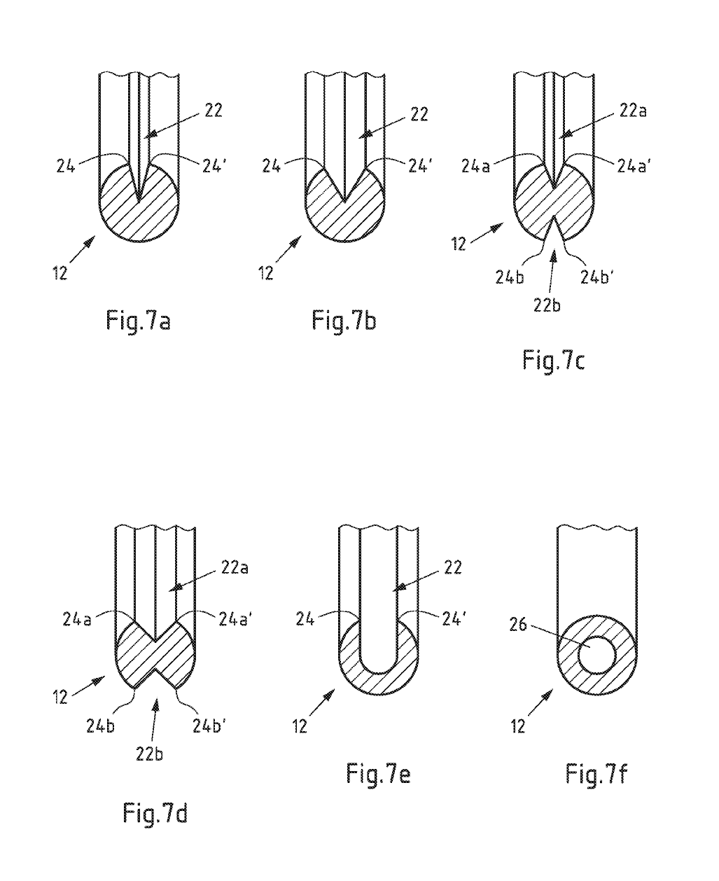

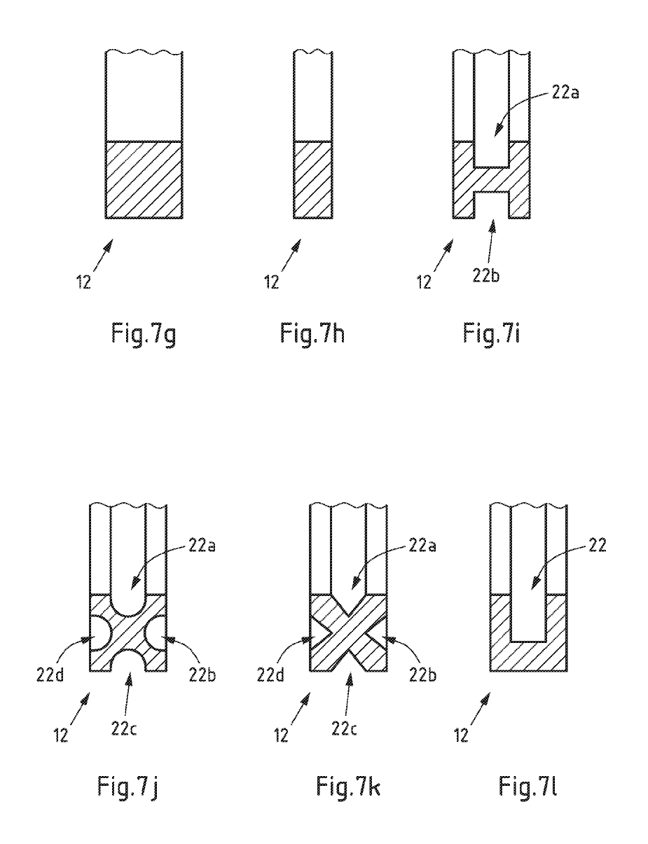

FIG. 7a-l various exemplary embodiments of cross-sections of the retaining element 12, in diagrammatic views.

In the description below of the various exemplary embodiments according to the invention, the same components carry the same reference signs, although the components in the various exemplary embodiments may differ in their dimensions or forms.

FIG. 1a shows in a sectional view a first exemplary embodiment of a fitting 2 for producing a leak-tight connection with the pipe end 4, in the uncompressed state. The fitting 2 has a pressing portion 6 and a contact region 8. The contact region 8 has an inner diameter which corresponds approximately to the outer diameter of the pipe end 4, so that the pipe end 4 can be retained by means of contact in the contact region 8. The pressing portion 6 is also configured for insertion of the pipe end 4 via corresponding dimensioning.

A sealing element 10 and a retaining element 12 are arranged in the pressing region 6 of the fitting 2. An additional separating element 14 is provided which is arranged between the sealing element 10 and the retaining element 12. The retaining element 12 is configured so as to be substantially annular. The annular form of the retaining element 12 here defines a circumferential direction which in FIG. 1 runs perpendicularly to the section plane, and an axial direction which in FIG. 1 corresponds to the preferential direction of the pipe end 4 and runs in the section plane.

FIG. 1a furthermore shows a pressing tool 16 which serves for a radially inwardly directed compression of the pressing portion 6 and hence for production of the leak-tight connection between the fitting 2 and pipe end 4.

FIG. 1b shows the fitting 2 and pipe end 4 after compression by the pressing tool 16. The sealing element 10, which consists of an elastic material and for example takes the form of an O-ring, is deformed such that it lies tightly against the pressing portion 6 and pipe end 4. By means of the sealing element 10, the created connection is sealed tightly against fluids and/or gases which may be conveyed through the pipe end 4 and the fitting 2. A mechanical fixing and in particular an inseparability of the connection is achieved by the retaining element 12, which is moulded into the material of the pipe end 4 by the compression. This mechanically fixes the connection.

Furthermore, due to the special design of the retaining element 12, an additional sealing effect is achieved which protects the connection of the fitting 2 and pipe end 4 from external influences, for example from the penetration of corrosive media. The design of the retaining element 12 is explained below in connection with the description of the following figures.

FIGS. 2 to 5 for this show various exemplary embodiments of the retaining element 12. The retaining elements 12 are configured so as to be substantially annular and have an open circular ring form. The retaining elements 12 have two ends 18, 18′ relative to the circumferential direction. At least one contact surface 20, 20′, 20a, 20b, 20a′, 20b′ is arranged at each of the two ends 18, 18′ and runs at least partially in the circumferential direction.

FIG. 2a shows a first exemplary embodiment of a retaining element 12 in a front view. The contact surfaces 20, 20′ are formed via surfaces which are inclined relative to the circumferential direction, so that the contact surfaces 20, 20′ run partially in the circumferential direction. If a fitting is compressed with the retaining element 12, a compression force is exerted on the retaining element 12 in the circumferential direction so that the circumference of the retaining element 12 is reduced. The contact surfaces 20, 20′ may then be brought into contact with each other on compression of the pressing portion. The retaining element 12 is thus brought into a closed annular form under compression, whereby an additional sealing effect of the retaining element 12 is achieved.

Due to the design of the contact surfaces 20, 20′ as surfaces running at least partially in the circumferential direction of the retaining element 12, it is guaranteed that even on dimensional deviations or tolerances in the elements to be compressed, both the additional sealing effect and a compressibility in the circumferential direction are retained. Also, a particularly even compression of the retaining element 12 is achieved.

As evident from the top view of the retaining element 12 in FIG. 2b, the contact surfaces 20, 20′ run substantially parallel. Thus on compression, a large contact area between the contact surfaces 20, 20′ is achieved.

FIGS. 3a and 3b show a second exemplary embodiment of a retaining element 12 in a front view and top view respectively. In this exemplary embodiment, two contact surfaces 20a, 20b; 20a′, 20b′ are formed at each of the two ends 18, 18′, and are configured as surfaces inclined relative to the circumferential direction. As a whole, this creates a V-shaped recess in the annular form of the retaining elements 12 with contact surfaces 20a, 20b; 20a′, 20b′ running substantially parallel to each other.

FIGS. 4a and 4b show a third exemplary embodiment of a retaining element 12 in a front view and top view respectively. The contact surfaces 20, 20′ are formed as surfaces rounded relative to the circumferential direction, or as ball portions. The contours of the contact surfaces 20, 20′ are substantially parallel to each other.

FIGS. 5a and 5b show a fourth exemplary embodiment of a retaining element 12 in a front view and top view respectively. The contact surfaces 20, 20′ are formed as surfaces rounded relative to the circumferential direction or as ball domes.

FIGS. 2 to 5 show exemplary embodiments of the retaining element 12 which are configured to be brought into a closed annular form under compression, i.e. the retaining element 12 in FIGS. 2 to 5 has an open annular form before compression and a closed annular form after compression.

In an alternative embodiment of the fitting, the retaining element 12 already has a closed annular form before compression. FIGS. 6a and 6b for this show further exemplary embodiments of the retaining element 12 in perspective views.

The fifth exemplary embodiment of the retaining elements 12 in FIG. 6 a has a circular cross-section. The ends 18,18′ of the retaining element 12 are arranged offset to each other in the axial direction. In this way, on compression of the retaining element 12 in the circumferential direction, the ends 18,18′ of the retaining element 12 are pushed past each other. Contact surfaces 20, 20′ are arranged on the side of the retaining element 12 in the axial direction. On compression of the retaining element 12 or on compression of the retaining element 12 in the circumferential direction, the contact surfaces 20, 20′ are pushed onto each other and thus come into contact.

FIG. 6b shows a sixth exemplary embodiment of the retaining element 12. The cross-section of the retaining element 12 is here rectangular. Here too, the ends 18, 18′ of the retaining element 12 are arranged offset to each other in the axial direction before compression, but lie in one plane. Thus a minimal use of material is achieved for a closed annular form in the uncompressed state.

FIG. 7 shows various exemplary embodiments of cross-sections of the retaining element 12. FIGS. 7a-f show variations of elliptical or circular cross-sections, while FIGS. 7g-l show variations of rectangular cross-sections.

FIG. 7a shows a circular cross-section of the retaining element 12 in which a V-shaped recess 22 is provided. The V-shaped recess 22 provides two edges 24, 24′ which for example may serve for pressing into the material of the pipe end. FIG. 7b shows a similar cross-section as FIG. 7a, with a larger opening angle of the V-shaped recess 22, whereby the shape of the edges 24, 24′ may be varied.

FIG. 7c shows a circular cross-section of the retaining element 12 with two V-shaped recesses 22a, 22b which are arranged on opposite sides of the cross-section. Accordingly, four edges 24a, 24b; 24a′, 24b′ are provided which in particular may be pressed firstly into the material of the pipe end and secondly into the wall of the fitting. FIG. 7d shows a similar cross-section to FIG. 7c with a larger opening angle of the recesses 22a, 22b, whereby the shape of the edges 24a, 24b; 24a′, 24b′ may be varied.

FIG. 7e shows a circular cross-section of the retaining element 12 with a recess 22 in the form of a slot or a groove with a semicircular base. Here again, two edges 24, 24′ are present for pressing.

FIG. 7f shows a circular cross-section of the retaining element 12 with a circular cavity 26 for saving material and weight.

FIG. 7g shows, in a particularly simple embodiment, a square cross-section of the retaining element 12. Similarly, FIG. 7h shows a rectangular cross-section.

FIGS. 7i-l now show variations of recesses 22, 22a, 22b, 22c, 22d in a square cross-section. FIG. 7i shows two rectangular recesses 22a, 22b. FIGS. 7j and 7k each show four recesses 22a, 22b, 22c, 22d in the form of semicircles or rectangles. FIG. 7l shows a rectangular recess 22. With the embodiments shown in FIGS. 7g-l, again edges are produced in the cross-section which can be pressed into the material of the pipe end and/or into the wall of the fitting.

1. A fitting for producing a leak-tight connection with a pipe end, comprising:
at least one pressing portion configured for insertion of a pipe end and compression;
at least one sealing element; and
at least one retaining element,
wherein the sealing element and the retaining element are arranged in the pressing portion,
wherein the retaining element is substantially annular,
wherein the annular form defines a circumferential direction and an axial direction,
wherein the retaining element has two ends in relation to the circumferential direction,
wherein the retaining element has at each of the two ends at least one contact surface which extends at least partially in the circumferential direction,
wherein the contact surfaces are configured to be brought into contact with each other upon compression of the pressing portion, and
wherein the cross-section of the retaining element in the circumferential direction is formed so as to be substantially elliptical or substantially rectangular, and
the cross-section of the retaining element in the circumferential direction has at least a recess, wherein, with the at least one recess, cutting edges which can be pressed into the material of the pipe end and/or into the wall of the fitting arise in fee cross-section.

2. The fitting according to claim 1, wherein the retaining element is configured to be brought into a closed annular form by compression of the pressing portion.

3. The fitting according to claim 1, wherein the contact surfaces are formed via at least one surface inclined relative to the circumferential direction or via rounded surfaces.

4. The fitting according to claim 1, wherein the contact surfaces run substantially parallel to each other.

5. The fitting according to claim 1, wherein the ends of the retaining element are arranged offset to each other in the axial direction.

6. (canceled)

7. The fitting according to claim 1, wherein the at least one recess is configured so as to be rectangular, V-shaped, or in the form of a circle portion.

8. The fitting according to claim 1, wherein the additional separating element is provided, wherein the additional separating element is arranged between the sealing element and the retaining element.

9. A system for producing a leak-tight connection comprising:
a fitting according to claim 1, and
a pipe end,
wherein the inner surface of the pressing portion, the retaining element, and the sealing element are adapted to the outer surface of the pipe end.

10. A method for producing a leak-tight connection between a fitting according to claim 1 and a pipe end, comprising the following steps:
inserting the pipe end at least into the pressing portion of the fitting,
compressing the fitting into at least at the pressing portion wherein the sealing element between the fitting and the pipe end is deformed and the at least one retaining element is pressed into the material of the pipe end, and
wherein by means of the compression, the contact surfaces of the retaining element are brought into contact with each other.
